(19) United States
(12) Patent Application Publication
(10) Pub. No.: US 2015/0200843 A1
(43) Pub. Date: Jul. 16, 2015

(54) Packet Labels For Identifying Synchronization Groups of Packets

(71) Applicants: Daniel C. Frost, Feltham (GB); Clarence Filsfils, Brussels (BE); Simon James Trevor Spraggs, Hants (GB); Stewart Frederick Bryant, Surrey (GB)

(72) Inventors: Daniel C. Frost, Feltham (GB); Clarence Filsfils, Brussels (BE); Simon James Trevor Spraggs, Hants (GB); Stewart Frederick Bryant, Surrey (GB)

(73) Assignee: Cisco Technology, Inc. a corporation of California, San Jose, CA (US)

(21) Appl. No.: 14/155,465

(22) Filed: Jan. 15, 2014

(51) Int. Cl. H04L 12/723; H04L 12/803; H04L 12/707

(52) U.S. Cl. CPC H04L 45/50; H04L 45/24; H04L 47/125

(57) ABSTRACT

In one embodiment, packet labels are used to identify synchronization groups of packets, such as for, but not limited to, performing processing of packets based on their corresponding synchronization group, as the synchronization label of a packet may define a current characteristic of the packet stream which is taken into account performing processing related to the packet. A plurality of synchronization groups of packets are generated and sent, by a first packet switching device, to a second packet switching device, with each particular packet of the plurality of synchronization groups of packets including a same synchronization label in a label stack of said particular packet that is different than a synchronization label used with another of the plurality of synchronization groups of packets, and with each synchronization group of the plurality of synchronization groups of packets including a plurality of packets.

### TECHNICAL FIELD

The present disclosure relates generally to forwarding packets in a communications network.

### BACKGROUND

The communications industry is rapidly changing to adjust to emerging technologies and ever increasing customer demand. This customer demand for new applications and increased performance of existing applications is driving communications network and system providers to employ networks and systems having greater speed and capacity (e.g., greater bandwidth). In trying to achieve these goals, a common approach taken by many communications providers is to use packet switching technology.

Reliably communicating information in a network is important. Service providers enter into Service Level Agreements (SLA) which set forth certain performance characteristics which must be met. Also, network operators desire to understand the performance of their network. Customers and network provides use various tools to measure certain operational characteristics of their networks.

### BRIEF DESCRIPTION OF THE DRAWINGS

The appended claims set forth the features of one or more embodiments with particularity. The embodiment(s), together with its advantages, may be best understood from the following detailed description taken in conjunction with the accompanying drawings of which:

FIG. 1 illustrates a network operating according to one embodiment;

FIG. 2A illustrates a packet switching device according to one embodiment;

FIG. 2B illustrates an apparatus according to one embodiment;

FIG. 3A illustrates a process according to one embodiment; and

FIG. 3B illustrates a process according to one embodiment.

### DESCRIPTION OF EXAMPLE EMBODIMENTS

### 1. Overview

Disclosed are, inter alia, methods, apparatus, computer-storage media, mechanisms, and means associated with packet labels for identifying synchronization groups of packets, such as for, but not limited to, performing processing of packets based on their corresponding synchronization group. In one embodiment, the synchronization label of a packet defines a current characteristic of the packet stream which is taken into account performing processing related to the packet.

One embodiment includes generating and sending a plurality of synchronization groups of packets, by a first packet switching device, to a second packet switching device, with each particular packet of the plurality of synchronization groups of packets including a same synchronization label in a label stack of said particular packet that is different than a synchronization label used with another of the plurality of synchronization groups of packets, and with each synchronization group of the plurality of synchronization groups of packets including a plurality of packets.

In one embodiment, the second packet switching device receives a plurality of received packets of the plurality of synchronization groups of packets said sent by the first packet switching device. The second packet switching device identifies for each received particular packet of the plurality of received packets which identified synchronization group of the plurality of synchronization groups of packets said received particular packet is a member based on the synchronization label included in said received particular packet. The second packet switching device corresponding synchronization processes said received particular packet according to a predetermined manner associated with said identified synchronization group.

In one embodiment, each of said synchronization labels overloads an identification to perform an identical function within a network, with the network including the first and second packet switching devices. In one embodiment, each label of said synchronization labels is an entropy label; and the identical function is load balancing across a plurality of paths in the network between the first and second packet switching devices such that a packet would take a same path of the plurality of paths for each of said synchronization labels. In one embodiment, each label of said synchronization labels is a virtual private network (VPN) label; and wherein the identical function is forwarding over a same VPN. In one embodiment, each label of said synchronization labels is a Multiprotocol Label Switching (MPLS) reserve label. In one embodiment, each label of said synchronization labels is a Multiprotocol Label Switching (MPLS) context label. In one embodiment, each of said synchronization labels differs from another of said synchronization labels by at least two bits.

In one embodiment, a different cryptography key is associated with each of the plurality of synchronization groups of packets; and wherein said corresponding synchronization processing includes selecting and using a particular cryptography key of said different cryptographic keys based on said identified synchronization group of the plurality of synchronization groups of packets. In one embodiment, said corresponding synchronization processing includes determining compliance with a service level agreement of packets associated with said identified synchronization group of the plurality of synchronization groups of packets.

### 2. Description

Disclosed are, inter alia, methods, apparatus, computer-storage media, mechanisms, and means associated with packet labels for identifying synchronization groups of packets, such as for, but not limited to, performing processing of packets based on their corresponding synchronization group.

Embodiments described herein include various elements and limitations, with no one element or limitation contemplated as being a critical element or limitation. Each of the claims individually recites an aspect of the embodiment in its entirety. Moreover, some embodiments described may include, but are not limited to, inter alia, systems, networks, integrated circuit chips, embedded processors, ASICs, methods, and computer-readable media containing instructions. One or multiple systems, devices, components, etc., may comprise one or more embodiments, which may include some elements or limitations of a claim being performed by the same or different systems, devices, components, etc. A processing element may be a general processor, task-specific processor, a core of one or more processors, or other co-located, resource-sharing implementation for performing the corresponding processing. The embodiments described hereinafter embody various aspects and configurations, with the figures illustrating exemplary and non-limiting configurations. Computer-readable media and means for performing methods and processing block operations (e.g., a processor and memory or other apparatus configured to perform such operations) are disclosed and are in keeping with the extensible scope of the embodiments. The term “apparatus” is used consistently herein with its common definition of an appliance or device.

The steps, connections, and processing of signals and information illustrated in the figures, including, but not limited to, any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of read the value, process said read value—the value must be obtained prior to processing it, although some of the associated processing may be performed prior to, concurrently with, and/or after the read operation). Also, nothing described or referenced in this document is admitted as prior art to this application unless explicitly so stated.

The term “one embodiment” is used herein to reference a particular embodiment, wherein each reference to “one embodiment” may refer to a different embodiment, and the use of the tem repeatedly herein in describing associated features, elements and/or limitations does not establish a cumulative set of associated features, elements and/or limitations that each and every embodiment must include, although an embodiment typically may include all these features, elements and/or limitations. In addition, the terms “first,” “second,” etc., are typically used herein to denote different units (e.g., a first element, a second element). The use of these terms herein does not necessarily connote an ordering such as one unit or event occurring or coming before another, but rather provides a mechanism to distinguish between particular units. Moreover, the phrases “based on x” and “in response to x” are used to indicate a minimum set of items “x” from which something is derived or caused, wherein “x” is extensible and does not necessarily describe a complete list of items on which the operation is performed, etc. Additionally, the phrase “coupled to” is used to indicate some level of direct or indirect connection between two elements or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive or open-ended and does not exclude additional, unrecited elements or method steps. Finally, the term “particular machine,” when recited in a method claim for performing steps, refers to a particular machine within the 35 USC §101 machine statutory class.

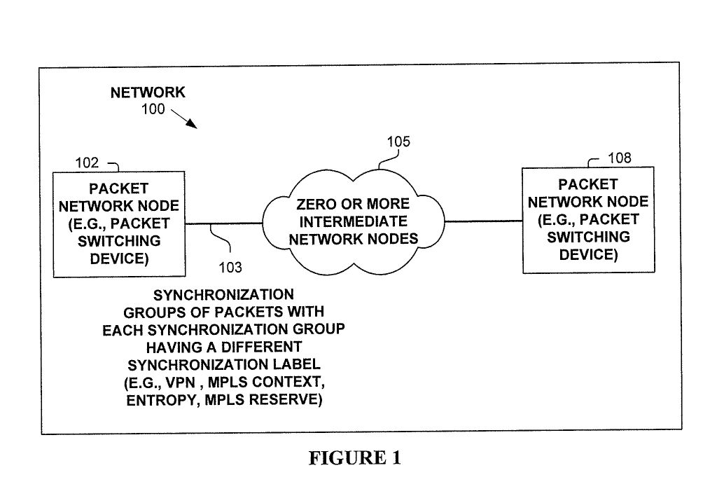

FIG. 1 illustrates a network 100 operating according to one embodiment. Shown are two packet network nodes 102 and 108 (e.g., packet switching devices, host devices, servers, computers) that are communicatively coupled via intermediate network 105 which includes zero or more packet switching or other communications devices. Streams of packets are communicated by packet network node 102 to packet network node 108. A stream of packets is a sequence of related packets (e.g., a connection; a packet flow such as, but not limited to, being defined by a common set of values in the header of a packet, e.g., source address, destination address, source port, destination port, protocol type).

In one embodiment, packet network node 102 divides a packet stream into synchronization groups of multiple packets and identifies each successive packet group with a different synchronization label in the label stack of a sent packet. A receiving packet network node 108 performs synchronization processing on all packets of a synchronization group identified by a synchronization label in a packet, and then switches to perform different synchronization processing on packets of a next, different synchronization label identified by a different synchronization label in a packet (hence, the use of the term “synchronization”). This synchronization processing may include, but is not limited to, determining compliance with a service level agreement of packets associated with a synchronization group, packet instrumentation, recording characteristics, using a different cryptography key for successive synchronization groups, not performing any synchronization processing for a synchronization group but performing synchronization processing for the next synchronization group in the succession of synchronization groups, etc.

In one embodiment, each of said synchronization labels differs from another of the synchronization labels by at least two bits (e.g., has a Hamming distance of at least two).

In one embodiment, each of the different labels of a successive pair of synchronization groups overloads an identification to perform an identical function within a packet switching device and/or network.

In one embodiment, each label is an entropy label; and wherein the identical function is load balancing across a plurality of paths in the network between sending and receiving packet switching devices such that a packet would take a same path through the network for each of the synchronization labels. In one embodiment, each of the entropy synchronization labels is selected such that each packet of a stream of packets will take a same path through the network that uses equal-cost multi-path routing (ECMP) based on the entropy label (and typically other fields of a packet).

In one embodiment, each label is a virtual private network (VPN) label; and wherein the identical function is forwarding over a same VPN. In one embodiment, a receiving packet switching device advertises multiple VPN labels for the exact same VPN. In other words, each of these VPN labels has the exact same forwarding semantics despite having different values. The number of labels available for representing a VPN is a scarce resource, and the number of VPN labels used to represent a same VPN reduces the availability of labels to represent different VPNs.

In one embodiment, each label is a Multiprotocol Label Switching (MPLS) reserve label (also referred to as a special purpose label). For example, one embodiment uses two or more different reserve labels in a sequence of reserve labels used for successive synchronization groups.

In one embodiment, each label of said synchronization labels is a Multiprotocol Label Switching (MPLS) context label. For example, one embodiment uses two or more different context label in a sequence of reserve labels used for successive synchronization groups.

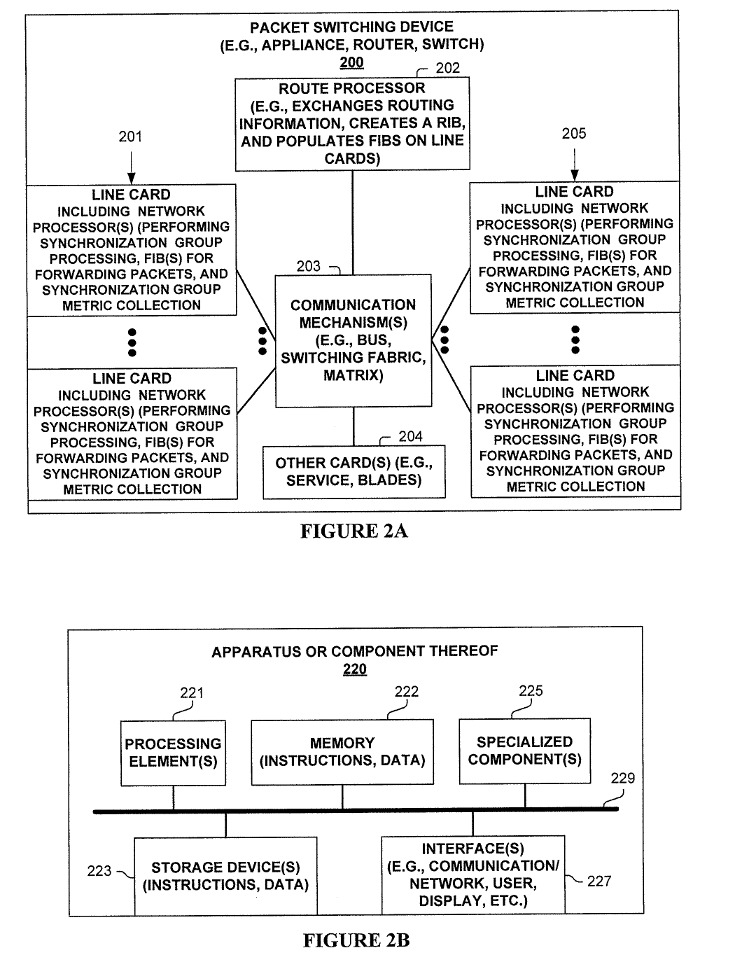

One embodiment of a packet switching device 200 is illustrated in FIG. 2A. As shown, packet switching device 200 includes multiple line cards 201 and 205, each with one or more network interfaces for sending and receiving packets over communications links (e.g., possibly part of a link aggregation group), and with one or more processing elements that are used in one embodiment associated with packet labels for identifying synchronization groups of packets. Packet switching device 200 also has a control plane with one or more processing elements 202 for managing the control plane and/or control plane processing of packets associated with packet labels for identifying synchronization groups of packets. Packet switching device 200 also includes other cards 204 (e.g., service cards, blades) which include processing elements that are used in one embodiment to process packets associated with packet labels for identifying synchronization groups of packets, and some communication mechanism 203 (e.g., bus, switching fabric, matrix) for allowing its different entities 201, 202, 204 and 205 to communicate.

Line cards 201 and 205 typically perform the actions of being both an ingress and egress line card, in regards to multiple other particular packets and/or packet streams being received by, or sent from, packet switching device 200. In one embodiment, line cards 201 and/or 205 perform synchronization processing for packets of a packet stream corresponding to the synchronization label received in a packet. In one embodiment, a synchronization label refers to one or more labels in a label stack of a packet.

FIG. 2B is a block diagram of an apparatus 220 used in one embodiment associated with packet labels for identifying synchronization groups of packets. In one embodiment, apparatus 220 performs one or more processes (which may include synchronization processing), or portions thereof, corresponding to one of the flow diagrams illustrated or otherwise described herein, and/or illustrated in another diagram or otherwise described herein.

In one embodiment, apparatus 220 includes one or more processing element(s) 221, memory 222, storage device(s) 223, specialized component(s) 225 (e.g. optimized hardware such as for performing lookup and/or packet processing operations, etc.), and interface(s) 227 for communicating information (e.g., sending and receiving packets, user-interfaces, displaying information, etc.), which are typically communicatively coupled via one or more communications mechanisms 229, with the communications paths typically tailored to meet the needs of a particular application.

Various embodiments of apparatus 220 may include more or fewer elements. The operation of apparatus 220 is typically controlled by processing element(s) 221 using memory 222 and storage device(s) 223 to perform one or more tasks or processes. Memory 222 is one type of computer-readable/computer-storage medium, and typically comprises random access memory (RAM), read only memory (ROM), flash memory, integrated circuits, and/or other memory components. Memory 222 typically stores computer-executable instructions to be executed by processing element(s) 221 and/or data which is manipulated by processing element(s) 221 for implementing functionality in accordance with an embodiment. Storage device(s) 223 are another type of computer-readable medium, and typically comprise solid state storage media, disk drives, diskettes, networked services, tape drives, and other storage devices. Storage device(s) 223 typically store computer-executable instructions to be executed by processing element(s) 221 and/or data which is manipulated by processing element(s) 221 for implementing functionality in accordance with an embodiment.

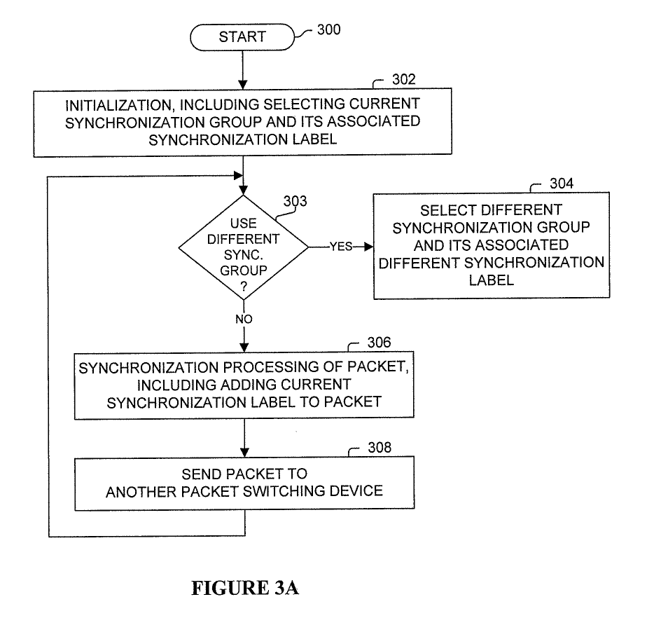

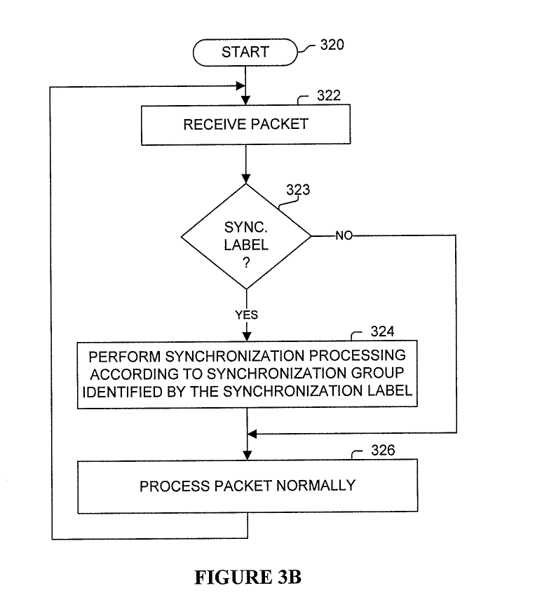

FIG. 3A illustrates a process performed in one embodiment by a packet network node sending packets of one or more streams of packets. Processing begins with process block 300. In process block 302, initialization is performed, which typically includes selecting a current synchronization group and its associated label for the one or more packet streams. In one embodiment, initialization includes communicating and/or negotiating with a receiving packet switching device concerning the use of synchronization groups/labels.

In process block 303 a determination is made whether to switch to a next synchronization group (e.g., after a predetermined time, number of packets or other metric, in response to some event or information). As determined in process block 303, if a different synchronization group should be used, then in process block 304, a different synchronization group is determined and its corresponding different synchronization label. In one embodiment, there are two synchronization groups and two different synchronization labels. In one embodiment, there are more than two synchronization groups and thus more than two different synchronization labels. In one embodiment, the synchronization groups sequence through a predetermined repeating pattern; while in one embodiment, they do not.

Processing proceeds to process block 306, therein synchronization processing is performed, which includes adding the current synchronization label to the label stack of a packet. In one embodiment, additional synchronization processing is performed, such as, but not limited to, encrypting or other processing using a cryptography key corresponding to the current synchronization group/label, and/or other synchronization processing by the sending network node. In process block 308, the packet is sent to another packet switching device. Processing returns to process block 303 to continue sending packets of the one or more packet streams.

FIG. 3B illustrates a process performed in one embodiment by a packet network node receiving packets of one or more streams of packets. Processing begins with process block 320. In process block 322, a packet is received. If the packet has a synchronization label as determined in process block 323, then in process block 324, synchronization processing is performed according to the synchronization group identified by the synchronization label (or simply that it is a different synchronization label that has been received in previous packets associated with a contiguously sent synchronization group of packets). Processing continues with process block 326, wherein the packet is processed normally. Processing returns to process block 322.

In view of the many possible embodiments to which the principles of the disclosure may be applied, it will be appreciated that the embodiments and aspects thereof described herein with respect to the drawings/figures are only illustrative and should not be taken as limiting the scope of the disclosure. For example, and as would be apparent to one skilled in the art, many of the process block operations can be re-ordered to be performed before, after, or substantially concurrent with other operations. Also, many different forms of data structures could be used in various embodiments. The disclosure as described herein contemplates all such embodiments as may come within the scope of the following claims and equivalents thereof.

What is claimed is:

1. A method, comprising:
generating and sending a plurality of synchronization groups of packets, by a first packet switching device, to a second packet switching device, with each particular packet of the plurality of synchronization groups of packets including a same synchronization label in a label stack of said particular packet that is different than a synchronization label used with another of the plurality of synchronization groups of packets, and with each synchronization group of the plurality of synchronization groups of packets including a plurality of packets;
receiving, by the second packet switching device, a plurality of received packets of the plurality of synchronization groups of packets said sent by the first packet switching device; and
identifying, by the second packet switching device, for each received particular packet of the plurality of received packets which identified synchronization group of the plurality of synchronization groups of packets said received particular packet is a member based on the synchronization label included in said received particular packet, and corresponding synchronization processing, by the second packet switching device, of said received particular packet according to a predetermined manner associated with said identified synchronization group.

2. The method of claim 1, wherein each label of said synchronization labels is a label from a group consisting of a virtual private network (VPN) label, Multiprotocol Label Switching (MPLS) context label, entropy label, and Multiprotocol Label Switching (MPLS) reserve label.

3. The method of claim 2, wherein each of said synchronization labels differs from another of said synchronization labels by at least two bits.

4. The method of claim 2, wherein a different cryptography key is associated with each of the plurality of synchronization groups of packets; and wherein said corresponding synchronization processing includes selecting and using a particular cryptography key of said different cryptographic keys based on said identified synchronization group of the plurality of synchronization groups of packets.

5. The method of claim 2, wherein said corresponding synchronization processing includes determining compliance with a service level agreement of packets associated with said identified synchronization group of the plurality of synchronization groups of packets.

6. The method of claim 1, wherein each said synchronization label is a virtual private network (VPN) label corresponding to a same VPN.

7. The method of claim 6, comprising: configuring, by the second packet switching device, a different VPN label for the same VPN for each of the plurality of synchronization groups of packets; and
wherein said synchronization processing includes forwarding said each received particular packet in a same manner for the VPN.

8. The method of claim 7, including advertising, by the second packet switching device, each of said different VPN labels for a same one or more VPN instances.

9. The method of claim 1, wherein a network includes the first, second and one or more additional packet switching devices; and
wherein each said synchronization label is an entropy label used by the network including to perform equal-cost multi-path routing (ECMP) such that each said synchronization label associated with one of the plurality of synchronization groups causes each ECMP decision to be the same as for another synchronization label of said synchronization labels.

10. The method of claim 1, wherein each of said synchronization labels overloads an identification to perform an identical function within a network, with the network including the first and second packet switching devices.

11. The method of claim 10, wherein each label of said synchronization labels is an entropy label; and wherein the identical function is load balancing across a plurality of paths in the network between the first and second packet switching devices such that a packet would take a same path of the plurality of paths for each of said synchronization labels.

12. The method of claim 10, wherein each label of said synchronization labels is a virtual private network (VPN) label; and wherein the identical function is forwarding over a same VPN.

13. The method of claim 10, wherein each label of said synchronization labels is a Multiprotocol Label Switching (MPLS) reserve label.

14. The method of claim 10, wherein each label of said synchronization labels is a Multiprotocol Label Switching (MPLS) context label.

15. A packet switching device, comprising:
one or more processing elements;
memory;
a plurality of interfaces configured for sending and receiving packets; and
one or more packet switching mechanisms configured to packet switch packets among said interfaces;
wherein said one or more processing elements are configured to perform operations, including generating a plurality of synchronization groups of packets, with said packets subsequently sent from one or more of the plurality of interfaces to a second packet switching device, with each particular packet of the plurality of synchronization groups of packets including a same synchronization label in a label stack of said particular packet that is different than a synchronization label used with another of the plurality of synchronization groups of packets, and with each synchronization group of the plurality of synchronization groups of packets including a plurality of packets.

16. The packet switching device of claim 15, wherein each label of said synchronization labels is a label from a group consisting of a virtual private network (VPN) label, Multiprotocol Label Switching (MPLS) context label, entropy label, and Multiprotocol Label Switching (MPLS) reserve label.

17. The packet switching device of claim 15, wherein each of said synchronization labels overloads an identification to perform an identical function within a network, with the network including the first and second packet switching devices.

18. The packet switching device of claim 17, wherein each label of said synchronization labels is an entropy label; and wherein the identical function is load balancing across a plurality of paths in the network between the first and second packet switching devices such that a packet would take a same path of the plurality of paths for each of said synchronization labels.

19. The packet switching device of claim 17, wherein each label of said synchronization labels is a virtual private network (VPN) label; and wherein the identical function is forwarding over a same VPN.

20. A packet switching device, comprising:
one or more processing elements;
memory;
a plurality of interfaces configured for sending and receiving packets; and
one or more packet switching mechanisms configured to packet switch packets among said interfaces;
wherein said one or more processing elements are configured to perform operations, including identifying for each received particular packet of a plurality of received packets of a plurality of synchronization groups of packets which identified synchronization group of the plurality of synchronization groups of packets said received particular packet is a member based on the synchronization label included in said received particular packet, and corresponding synchronization processing of said received particular packet according to a predetermined manner associated with said identified synchronization group.
